(19) United States
(12) Patent Application Publication
(10) Pub. No.: US 2010/0215337 A1
(43) Pub. Date: Aug. 26, 2010

(54) VIDEO REPLAY DEVICE AND VIDEO REPLAY PROGRAM

(75) Inventor: Tetsuya KONISHI, Machida-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/704,093

(22) Filed: Feb. 11, 2010

(30) Foreign Application Priority Data
Feb. 17, 2009 (JP) 2009-034108
Feb. 10, 2010 (JP) 2010-027297

(51) Int. Cl. H04N 5/91

(52) U.S. Cl. 386/68; 386/E05.003

(57) ABSTRACT

A video replay device replays a video in which are recorded a plurality of images photographed at a predetermined number of frames per unit time and audio that has been captured at a predetermined sampling interval. This video relay device comprises an extraction unit that extracts beat periods from the recorded audio data, a separation unit that separates the plurality of images for each beat period of the audio, and a display unit that replays the plurality of images according to the beat period.

### INCORPORATION BY REFERENCE

The disclosures of the following priority applications are herein incorporated by reference: Japanese Patent Application No. 2009-34108 filed Feb. 17, 2009 and Japanese Patent Application No. 2010-27297 filed Feb. 10, 2010.

### BACKGROUND OF THE INVENTION

1. Field of the Invention

The present invention relates to a video replay device and a video replay program.

2. Description of Related Art

The following type of image replay device is per se known from Japanese Laid-Open Patent Publication 2004-247899. In this image replay device, a plurality of frames shot at predetermined intervals are automatically extracted from a series of image data that constitutes a video that is to be the subject of replay, and these images are displayed upon a monitor arranged in time series order. The user selects one of these frames, and shift forward or backward from it frame by frame to select a frame, and then replay of the video is performed from that frame.

However, with the prior art image replay device described above, while it is possible to perform a frame-by-frame replay in units of video frames or fields, it has not been possible to replay a video in which a scene in which people are dancing to music has been photographed, by units of beats synchronized with the rhythm of the music. On the other hand, when slow replay is performed at less than around 50% of real time, it becomes impossible to hear voices properly. Due to this, with such a prior art type image replay device, it has not been possible to check whether or not the action and the music are mutually in step.

### SUMMARY OF THE INVENTION

A video replay device according to a 1st aspect of the present invention replays a video in which are recorded a plurality of images photographed at a predetermined number of frames per unit time and audio that has been captured at a predetermined sampling interval. This video replay device comprises: an extraction unit that extracts beat periods from the recorded audio data; a separation unit that separates the plurality of images for each beat period of the audio; and a display unit that replays the plurality of images according to the beat period.

According to a 2nd aspect of the present invention, in the video replay device of the 1st aspect, it is preferred that the display unit replays the images according to the beat period at a normal video replay speed.

According to a 3rd aspect of the present invention, in the video replay device of the 1st or 2nd aspect, the display unit may display the audio according to the beat period as a graph.

According to a 4th aspect of the present invention, the video replay device of any one of the 1st through 3rd aspects can further comprise an audio replay unit that replays the audio according to the beat period at a normal audio replay speed.

A video replay program according to a 5th aspect of the present invention, for replaying with a computer a video in which are recorded a plurality of images photographed at a predetermined number of frames per unit time and audio that has been captured at a predetermined sampling interval, causes the computer to execute: an extraction step of extracting beat periods from the recorded audio data; a separation step of separating the plurality of images for each beat period of the audio; and a display step of replaying the plurality of images according to the beat period.

According to a 6th aspect of the present invention, in the video replay program of the 5th aspect, it is preferred that the computer is caused to execute the display step by replaying the images according to the beat period at a normal video replay speed.

According to a 7th aspect of the present invention, in the video replay program of the 5th or 6th aspect, the computer may be caused to execute the display step by displaying the audio according to the beat period as a graph.

According to an 8th aspect of the present invention, the replay program of any one of the 5th through 7th aspects can be further caused to execute an audio replay step of replaying the audio according to the beat period at a normal audio replay speed.

According to the present invention, it is possible to check in a simple and easy manner whether or not the movement of the photographic subject that has been photographed is correctly matched to the rhythm of the recorded audio.

### BRIEF DESCRIPTION OF THE DRAWINGS

FIG. 1 is a figure showing the structure of an image-capturing device that is equipped with a video replay device according to an embodiment of the present invention;

FIG. 2 is a figure showing an example of display of frame images and a corresponding audio signal;

FIG. 3 is a flow chart showing a portion of processing by a video replay program; and

FIG. 4 is a flow chart showing processing by this video replay program continuing on from the FIG. 3 flow chart.

### DESCRIPTION OF PREFERRED EMBODIMENTS

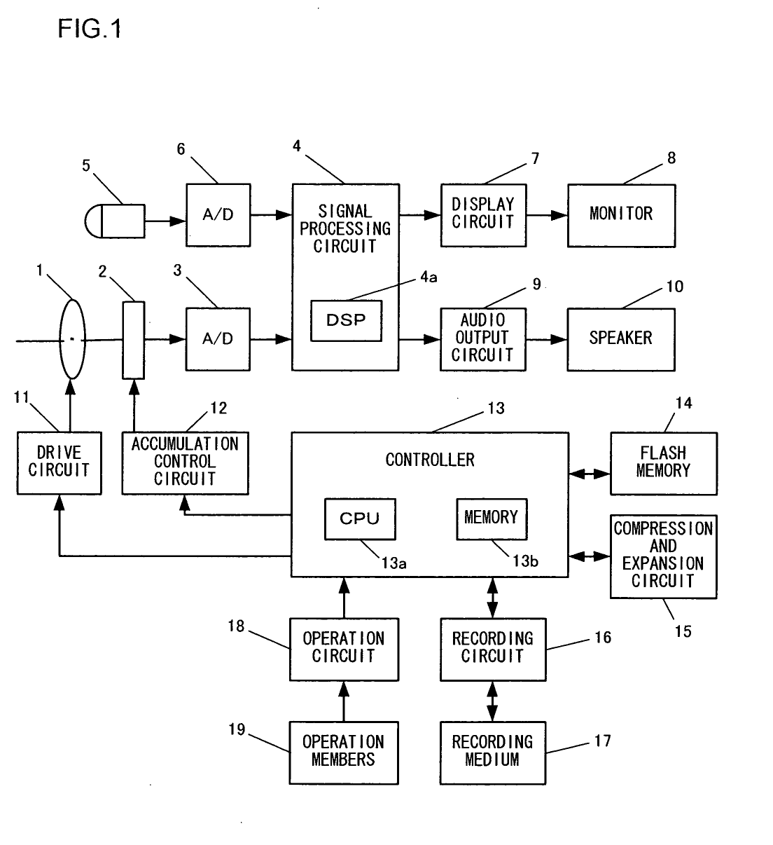

FIG. 1 is a figure showing the structure of an image-capturing device that is equipped with a video replay device according to an embodiment of the present invention. It should be understood that elements and circuitry of this image-capturing device that are not directly related to the invention of the present application are not shown in FIG. 1, and explanation thereof is omitted. A photographic lens 1 includes a zooming lens, a focusing lens, an aperture, a lens ROM and so on not shown in the figures, and images an image of a photographic subject upon the photographic image surface of an imaging element 2. This imaging element 2 is an image sensor that includes a CCD or a CMOS or the like, and captures the image of the photographic subject imaged upon its photographic image surface and outputs an analog image signal. An A/D converter 3 converts this analog image signal from the imaging element 2 into a digital image signal, and outputs it to a signal processing circuit 4. A microphone 5 captures sound around the image-capturing device, and outputs an analog audio signal. And an A/D converter 6 converts this analog audio signal from the microphone 5 into a digital audio signal, and outputs it to the signal processing circuit 4.

The signal processing circuit 4 includes a DSP 4a, and performs various types of processing upon the digital image signal and the digital audio signal. Upon the image signal, it may perform interpolation processing in which the output of pixels in three primary colors arranged as a Bayer array is interpolated, processing for generating a luminance signal and a color-difference signal, gamma correction processing, contour correction processing, white balance correction processing, and so on. Furthermore, processing is performed upon the audio signal to extract the beat and so on. Yet further, while the signal processing circuit 4 generates frame images for display from the video image signal that has been photographed, it also extracts the beat from the audio signal, and replays the frame images and the audio while dividing up the frame images and the audio signal beat by beat. It should be understood that, in video photography, along with images being photographed at a predetermined number of frames per unit time, for example 30 frames per minute, also audio is recorded at predetermined sampling intervals, but the moments the frame images are photographed and the moments at which the audio is sampled are not synchronized. The details of how these frame images and audio are divided and replayed beat by beat will be described hereinafter. A display circuit 7 replays the video upon a monitor 8, and also displays information of various types. And an audio output circuit 9 replays the audio through a speaker 10.

A drive circuit 11 drives the zooming lens, the focusing lens, and the aperture of the photographic lens 1. An accumulation control circuit 12 controls the electric charge accumulation operation of the imaging element 2. A controller 13 includes a CPU 13a and a memory 13b and so on, and performs photography control, focus adjustment control, image processing, audio processing, video and audio recording control, and so on. A flash memory 14 is a storage device for temporarily storing images that have been photographed. A compression and expansion circuit 15 performs compression and expansion of the image data. A recording circuit 16 records video and audio upon a recording medium 17 such as a memory card or the like. And an operation circuit 18 inputs operating signals from operation members 19.

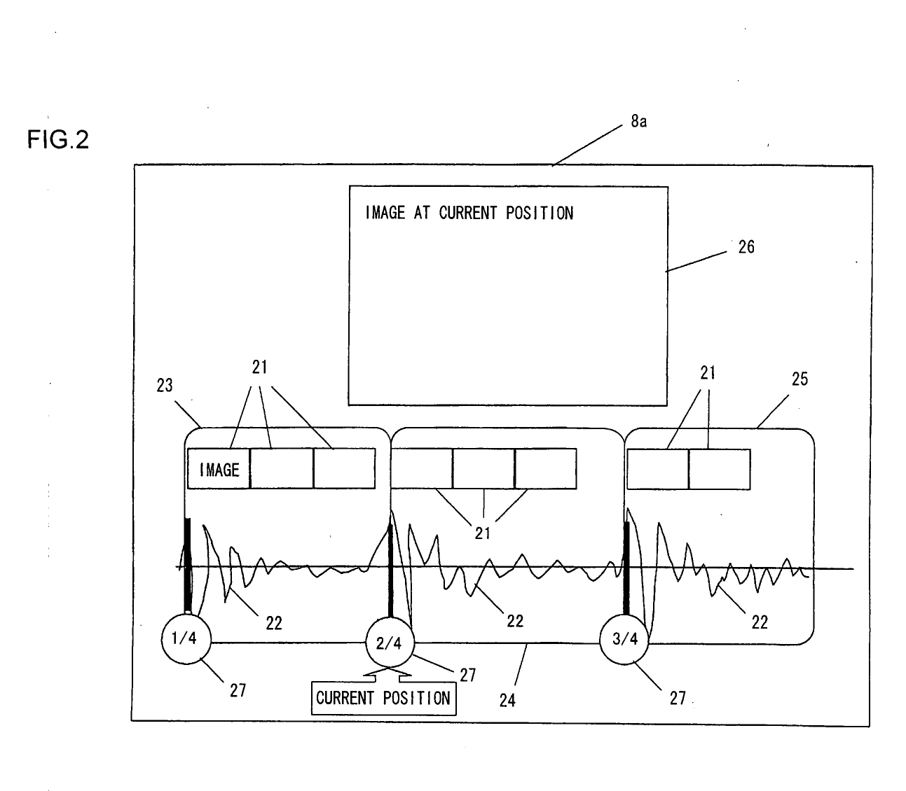

FIG. 2 is a figure showing an example of display of frame images upon the display screen 8a of the monitor 8 along with the corresponding audio signal, beat by beat. It should be understood that here the explanation will assume an example in which video and audio have been photographed of a scene that shows dancing being performed while being accompanied by music with beats in quadruple time. The frame images for display and the audio signal that are generated by the signal processing circuit 4 are temporarily stored in the flash memory 14 via the controller 13. When, due to the user operating the operation members 19, a request for replay of frame images and audio beat by beat has been received, the signal processing circuit 4 extracts the beats from the digital audio signal series stored in the flash memory 14, and divides up the frame images and the audio signal beat by beat. And, for these frame images and the audio signal that have been divided up into beats, along with only the portion thereof relating to certain beats being displayed upon the display screen 8a of the monitor 8, also the image at the current position is displayed.

FIG. 2 shows the frame images 21 and the audio signal 22 for each of three beat periods 23 through 25 of the music as displayed at the lower portion of the display screen 8a, separated into groups of frames for each beat, with the frame image 26 at the current position being displayed as enlarged at the upper portion of the display screen 8a. Here, from the frame images and the audio signal for the successive beats in quadruple time, the frame images and the audio signal are displayed for the first beat (the beat period 23), the second beat (the beat period 24), and the third beat (the beat period 25) are displayed. Furthermore, the sound pressure level of the audio signal 22 at each sampling time instant is displayed as a zigzag line graph, with the sound pressure being shown along the vertical axis and time being shown along the horizontal axis.

Here, along with the image data for each frame image 21 being recorded, data specifying the time instant at which that frame image 21 was photographed is also recorded. On the other hand, the sampling time instants for the audio in the audio signal 22 are also recorded, so that it is possible to know the sampling time instants of each sound pressure level data. On the basis of the time instant data for the audio signal, beat by beat, the signal processing circuit 4 extracts the time instants at which each of the beat periods 23 through 25 starts and stops, and allocates the frame images 21 to their corresponding beat periods 23 through 25, according to the time spans of these beat periods 23 through 25. In FIG. 2, three consecutive frame images 21 are allocated corresponding to each of the beat periods 23 and 24 for the first beat and the second beat respectively, while two consecutive frame images 21 are allocated corresponding to the beat period 25 for the third beat. It should be understood that the frame images 21 for the beat periods 23 through 25 are arranged in order in time series from the left of the screen to its right. Moreover, for each of these beat periods 23 through 25, the audio signal 22 is displayed as a graph of sound pressure level.

For each of the beat periods 23 through 25, at the lower left corner of its area, a cycle number 27 is displayed that specifies the number of bar and the number of the beat in its bar. In FIG. 2, a cycle number 27 is displayed for the beat period 23 specifying that this is the first beat in the fourth bar; a cycle number 27 is displayed for the beat period 24 specifying that this is the second beat in the fourth bar; and a cycle number 27 is displayed for the beat period 25 specifying that this is the third beat in the fourth bar. When the user sets a cycle number 27 for the beat period that is initially displayed (here, the beat period 23) using the operation members 19 (refer to FIG. 1), cycle numbers 27 for the beat periods before and after it are set by being automatically allocated by the controller 13.

Now, considering for example the beat period 23 shown in FIG. 2, the time instant for which its beat has been extracted, and the time instant that the frame image 21 at the head end of the beat period 23 was photographed, are not always limited to being coincident; rather, in many or even most cases, they deviate from one another. Due to this, it is necessary to correct this type of deviation between the video and the audio. Thus, in this embodiment, while the user looks at the frame images 21 and the audio signal 22 for the beat periods 23 through 25 that are displayed upon the display screen 8a of the monitor 8, he performs operation to correct the time offset between the video and the audio by operating the operation members 19 (refer to FIG. 1). When this is done, the frame images 21 that are displayed for the beat periods 23 through 25 are shifted leftwards or rightwards by one frame; and thus, it is possible to shift the correspondence relationship between the audio signal 22 and the frame images 21.

For example, for the beat period 23, if the frame image 21 at the head (the left end) with respect to the beat time instants that correspond to this beat period is delayed, then the frame images 21 should be shifted in the rightwards direction so that a frame image that was photographed earlier than that head frame image 21 now becomes the new head image. Conversely, if the frame image 21 is too early with respect to the beat time instants, then the frame images 21 should be shifted in the leftwards direction so that a frame image that was photographed later than that head frame image 21 (here, the neighboring frame image on the right) now becomes the new head image.

Next. when the user operates a beat forward button (not shown in the figures) of the operation members 19 once, the beat periods 23 through 25 displayed in FIG. 2 are shifted by one beat period in the leftwards direction upon the screen 8a, so that the beat period 23 at the left end disappears, and a new beat period appears at the right end. At this time, the beat period 24 that, up until now, was being displayed as the beat period for the current position at the center of the screen is shifted to the left end, while the beat period 25 that now is shifted to the center of the screen in place thereof becomes the new beat period at the current position. Furthermore, along with the series of frame images 21 (here, three frames) for the beat period 24 at the current position image 26 being replayed and displayed at normal speed, in other words at the same speed as during photography, the audio signal 22 for the beat period 24 is also replayed and output from the speaker 10 (refer to FIG. 1) at normal speed, in other words at the same speed as during photography.

It should be understood that although, by operating a beat reverse button (not shown in the figures) of the operation members 19, it is also possible to perform reverse of the beat periods, in this case replay of the video image and the audio is not performed for each beat period. Furthermore while, by operating a beat fast forward button or a beat fast reverse button (neither of which is shown in the figures) of the operation members 19, it is possible to perform fast forward or fast reverse of the beat periods, in this case as well, replay of the video image and the audio is not performed.

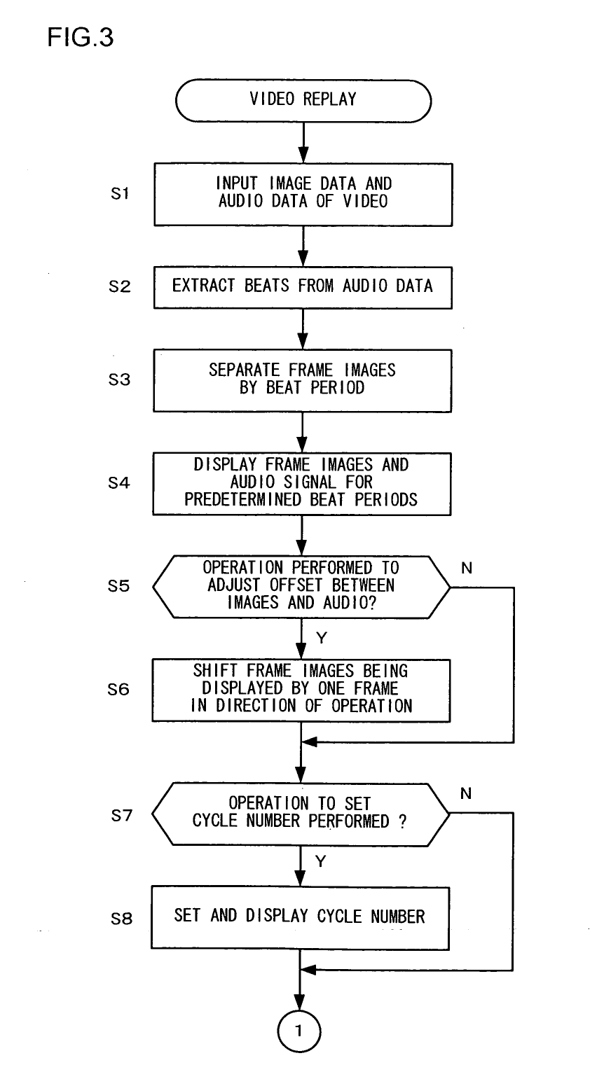

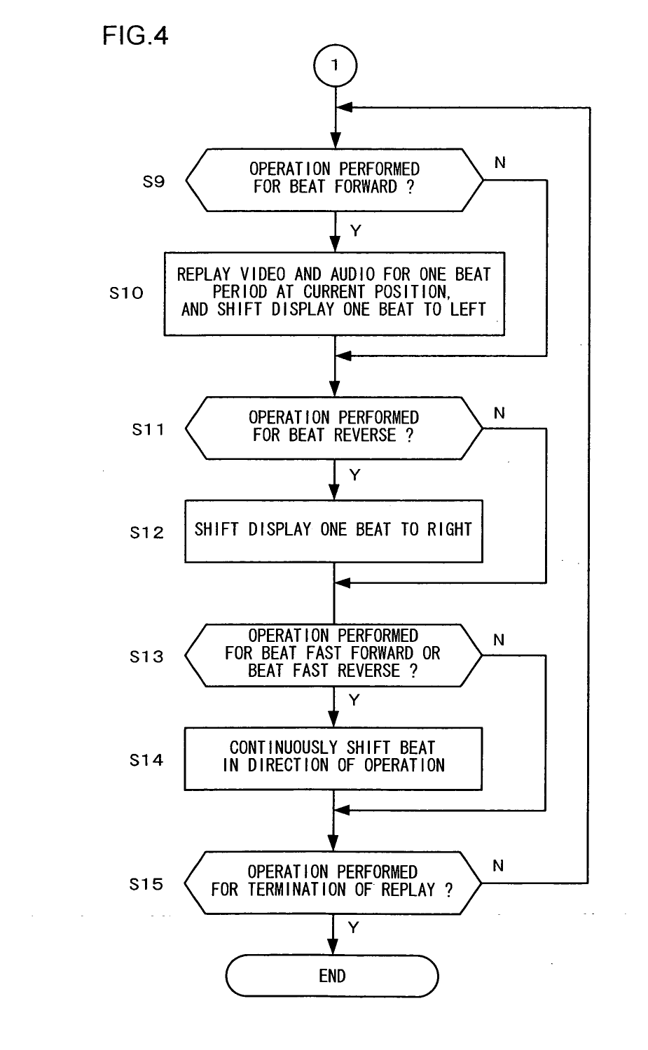

FIGS. 3 and 4 are flow charts showing the flow of processing of the video replay program according to this embodiment. The replay operation for video and audio in units of beats will now be explained by reference to these flow charts and FIG. 2. When, by the user employing the operation members 19, operation is performed for starting the replay of video and audio in units of beats, the CPU 13a of the controller 13 starts to execute this video replay program that is stored in the memory 19b.

In a first step 1, the CPU 13a reads in image data and audio data of a video from the flash memory 14. It should be understood that this image data consists of a series of frame images that can be displayed and photographic time instant data for each of these frame images, while the audio data consists of a series of sound pressure data and sound capture time instant data. In the next step 2, the CPU 13a extracts the beats from this audio data. Methods for extracting beats from an audio signal are per se known, and therefore the method of extraction will not be described here. Then in a step 3 the CPU 13a divides the series of frame images up by beat periods, on the basis of the photographic time instant data of the frame images and the captured sound time instant data of the audio data. And in the next step 4, as shown in FIG. 2, the CPU 13a displays the frame images 21 and the audio signal 22 for predetermined beat periods 23 through 25 upon the display screen 8a of the monitor 8.

Next in a step 5 the CPU 13a makes a decision as to whether or not operation for adjusting the offset between the image and the audio has been performed by the user employing the operation members 19, and if operation has been performed then the flow of control proceeds to a step 6. In this step 6, the CPU 13a shifts the frame images 21 that are being displayed by one frame unit in the direction of operation. This operation is performed until the offset adjustment operation is terminated by the user. Then in a step 7 the CPU 13a makes a decision as to whether or not operation to set a cycle number has been performed by the user employing the operation members 19, and if such operation has been performed, then the flow of control proceeds to a step 8. In this step 8, the CPU 13a sets and displays the cycle number 27 to the beat period 24 that is being displayed in the current position on the display screen 8a (i.e. in the center position thereof), and also performs assignment of cycle numbers according to the cycle number 27 of the current position to the beat periods 23, 25, . . . before and after it.

Next in a step 9 of the FIG. 4 flow chart, the CPU 13a makes a decision as to whether or not the beat forward button of the operation members 19 has been operated, and if it has been operated then the flow of control proceeds to a step 10. In this step 10, the CPU 13a replays the video and the audio for the beat period 24 at the current position, and also shifts the beat periods 23 through 25 upon the display screen 8a one beat period to the left. Then in the next step 11 the CPU 13a makes a decision as to whether or not the beat reverse button of the operation members 19 has been operated, and if it has been operated then the flow of control proceeds to a step 12. In this step 12, the CPU 13a shifts the beat periods 23 through 25 upon the display screen 8a one beat period to the right. Then in the next step 13 the CPU 13a checks whether either the beat fast forward button or the beat fast reverse button of the operation members 19 has been operated, and if either of them has been operated then the flow of control proceeds to a step 14. In this step 14, the CPU 13a shifts the beat periods in the direction of operation until operation is terminated.

Next in the step 15 the CPU 13a check whether or not video replay termination operation has been performed via the operation members 19. And if termination operation has been performed then this replay processing for video and audio beat by beat is terminated, whereas if termination operation has not been performed then the flow of control returns to the step 9 and the processing described above is repeated.

It should be understood that while, in the embodiment described above, an example has been shown of the video replay device and the video replay program according to the present invention being equipped to an image-capturing device, it would also be acceptable to arrange to provide a video replay program for causing a personal computer to execute the processing shown in FIGS. 3 and 4 upon a recording medium such as a CD or the like. When this video replay program is supplied to, installed upon, and executed by a personal computer, the steps of the processing shown in FIGS. 3 and 4 are executed by the computer according to the commands in the video replay program. By doing this, it is possible to perform replay of a video by beats upon the personal computer. In this case, it would be acceptable for a video that is stored in advance in the personal computer, or a video from a camera or a video camera that is connected to the personal computer, to be the subject of the replay by beats.

The display of the frame images and the audio signal shown by way of example in FIG. 2 and described in the embodiment above are only given for illustration, and are not limitative of the present invention. Moreover, the invention of the present application may be applied to music in any rhythm, and is not limited to music with beats in quadruple time.

According to the embodiment described above and variants thereof, it is possible to obtain the following beneficial operational effects. First, with a video replay device that replays a video in which are recorded a plurality of images photographed at a predetermined number of frames per unit time, and audio that has been captured at a predetermined sampling interval, it is arranged to extract beat periods from the recorded audio data, to separate the plurality of images for each beat period of the audio, and to replay the plurality of images according to the beat period. Due to this it is possible, while watching a video in which a scene including, for example, dancing accompanied by music has been photographed, to check in a simple and easy manner whether or not the operation is correctly matching the music to the beat. In other words, it is possible to check in a simple and easy manner whether or not the movement of the photographic subject that has been photographed is correctly matched to the rhythm of the recorded audio.

Furthermore, according to this embodiment, it is possible to check in a simple and easy manner whether or not the movement in each beat period is correctly matched to the rhythm of the audio, since it is arranged to replay the images according to the beat periods at the normal video replay speed.

Moreover, according to this embodiment, it is possible to check the audio by eye, since it is arranged to display the audio according to the beat period as a graph. Due to this, it is possible to check accurately and moreover in a simple and easy manner whether or not the movement in each beat period is correctly matched to the beat of the audio.

Even further, according to this embodiment, it is possible to check the beat of the music by ear, since it is arranged to replay the audio according to the beat period at the normal audio replay speed. Due to this, it is possible to check accurately and moreover in a simple and easy manner whether or not the movement in each beat period is correctly matched to the beat of the audio.

What is claimed is:

1. A video replay device that replays a video in which are recorded a plurality of images photographed at a predetermined number of frames per unit time, and audio that has been captured at a predetermined sampling interval, comprising:
an extraction unit that extracts beat periods from the recorded audio data;
a separation unit that separates the plurality of images for each beat period of the audio; and
a display unit that replays the plurality of images according to the beat period.

2. A video replay device according to claim 1, wherein the display unit replays the images according to the beat period at a normal video replay speed.

3. A video replay device according to claim 1, wherein the display unit displays the audio according to the beat period as a graph.

4. A video replay device according to claim 1, further comprising an audio replay unit that replays the audio according to the beat period at a normal audio replay speed.

5. A video replay program for replaying with a computer a video in which are recorded a plurality of images photographed at a predetermined number of frames per unit time, and audio that has been captured at a predetermined sampling interval, that causes the computer to execute:
an extraction step of extracting beat periods from the recorded audio data;
a separation step of separating the plurality of images for each beat period of the audio; and
a display step of replaying the plurality of images according to the beat period.

6. A video replay program according to claim 5, wherein the computer is caused to execute the display step by replaying the images according to the beat period at a normal video replay speed.

7. A video replay program according to claim 5, wherein the computer is caused to execute the display step by displaying the audio according to the beat period as a graph.

8. A video replay program according to claim 5, wherein the computer is further caused to execute an audio replay step of replaying the audio according to the beat period at a normal audio replay speed.
